(19) United States
(12) Patent Application Publication
(10) Pub. No.: US 2026/0058400 A1
(43) Pub. Date: Feb. 26, 2026

(54) CONNECTOR HOUSING ASSEMBLY AND COAXIAL CONNECTOR

(71) Applicants: Tyco Electronics (Shanghai) Co., Ltd., Shanghai (CN); Tyco Electronics Technology (SIP) Co., Ltd., Suzhou (CN)

(72) Inventors: Ling Liu, Suzhou (CN); Jianjia Qi, Shanghai (CN); Yuanming (Toney) Zhang, Shanghai (CN); Feng (Carlos) Pan, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/303,927

(22) Filed: Aug. 19, 2025

(30) Foreign Application Priority Data
Aug. 20, 2024 (CN) 202411151023.2

(51) Int. Cl. H01R 13/502; H01R 24/38; H01R 103/00

(52) U.S. Cl. CPC H01R 13/502; H01R 24/38; H01R 2103/00

(57) ABSTRACT

A connector housing assembly includes a rear cover and a housing. The rear cover has an outer peripheral wall and a rear end wall that enclose an accommodating chamber. The housing has a cylindrical portion and a flange portion formed at an end of the cylindrical portion. The flange portion is fixed to an outer side of the rear end wall by a fixing portion formed on the outer side of the rear end wall. An outer terminal of a connector is inserted into the cylindrical portion via a mounting hole formed in the rear end wall. The mounting hole is in communication with an inner cavity of the cylindrical portion.

### CROSS-REFERENCE TO RELATED APPLICATION

This application claims the benefit of the filing date under 35 U.S.C. § 119(a)-(d) of Chinese Patent Application No. CN 202411151023.2 filed on Aug. 20, 2024, the whole disclosure of which is incorporated herein by reference.

### FIELD OF THE INVENTION

The present invention relates to a connector housing assembly and, more particularly to a coaxial connector including the connector housing assembly.

### BACKGROUND OF THE INVENTION

In the prior art, a rear cover of a high-definition vehicle-mounted camera is formed by cold forging of aluminum alloy. The rear cover of the camera is integrally formed with a housing of a connector. Due to the high requirements for a snap feature and dimensions of the housing of the connector, cold heading forming is difficult to achieve and requires secondary processing. In addition, when different snaps are provided on the housings of the vehicle-mounted connectors, it is necessary to redesign and manufacture molds, resulting in very high costs.

Moreover, in the prior art, sealing between an outer terminal of the connector and the rear cover of the camera is achieved by assembling a sealing ring. A thickness of the sealing ring generally needs to be 2 mm or more. The thickness increases due to the squeeze after the sealing ring is assembled in place, and therefore, the sealing ring requires at least 3 mm or more of space in a height direction of the connector. Currently, the development trend of vehicle-mounted high-definition cameras is high pixel count and small volume. Therefore, the sealing ring limits its application to a certain extent.

### SUMMARY OF THE INVENTION

A connector housing assembly includes a rear cover and a housing. The rear cover has an outer peripheral wall and a rear end wall that enclose an accommodating chamber. The housing has a cylindrical portion and a flange portion formed at an end of the cylindrical portion. The flange portion is fixed to an outer side of the rear end wall by a fixing portion formed on the outer side of the rear end wall. An outer terminal of a connector is inserted into the cylindrical portion via a mounting hole formed in the rear end wall. The mounting hole is in communication with an inner cavity of the cylindrical portion.

### BRIEF DESCRIPTION OF DRAWINGS

The invention will now be described by way of example with reference to the accompanying figures, of which:

FIG. 1 is a perspective view of a coaxial connector according to an exemplary embodiment;

FIG. 2 is an axial cross-sectional view of the coaxial connector of FIG. 1;

FIG. 3 is an exploded view of the coaxial connector of FIG. 1;

FIG. 4 is an exploded axial cross-sectional view of the coaxial connector of FIG. 1;

FIG. 5 is another exploded axial cross-sectional view of the coaxial connector of FIG. 1;

FIG. 6 is another exploded axial cross-sectional view of the coaxial connector of FIG. 1;

FIG. 7 is a perspective view of a coaxial connector according to another embodiment;

FIG. 8 is an axial cross-sectional view of the coaxial connector of FIG. 7;

FIG. 9 is an exploded view of the coaxial connector of FIG. 7;

FIG. 10 is an exploded axial cross-sectional view of the coaxial connector of FIG. 7;

FIG. 11 is another exploded axial cross-sectional view of the coaxial connector of FIG. 7; and

FIG. 12 is another exploded axial cross-sectional view of the coaxial connector of FIG. 7.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

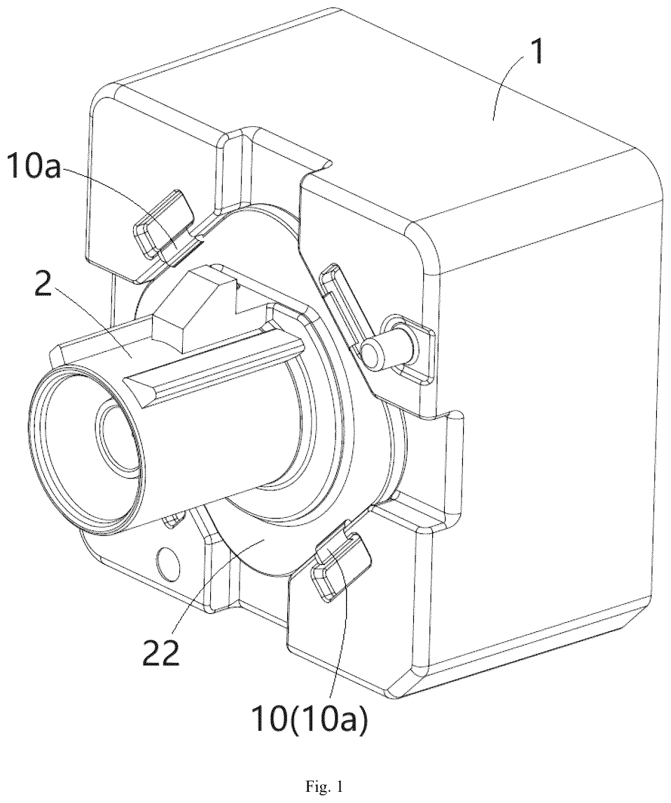

An exemplary embodiment of a connector housing assembly will now be described with reference to FIGS. 1-6. As shown in FIG. 1, the connector housing assembly includes a rear cover 1 and a housing 2. The rear cover 1 may be a one-piece stamped metal part or a one-piece die-cast metal part, and the housing 2 may be a one-piece injection-molded plastic part.

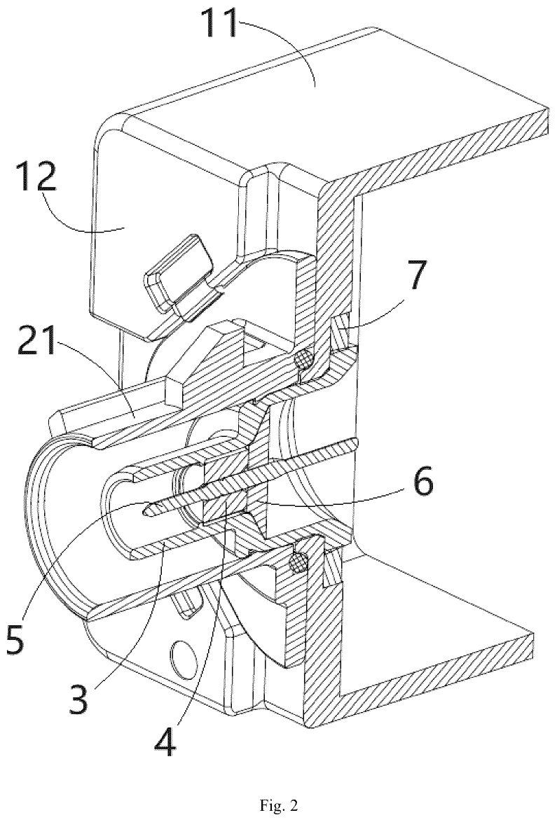

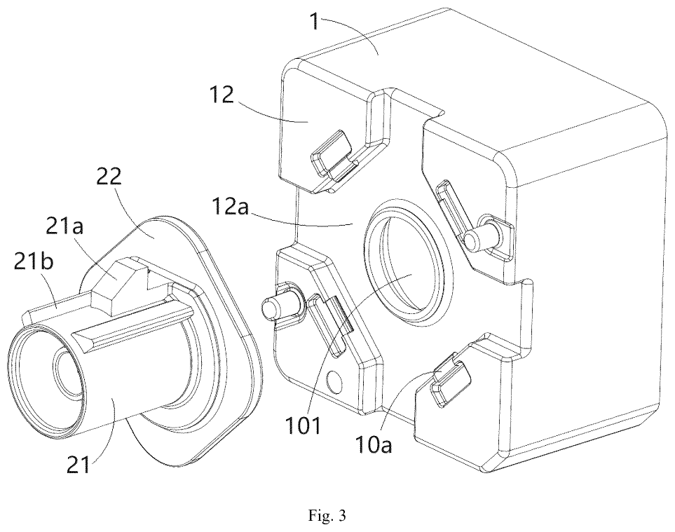

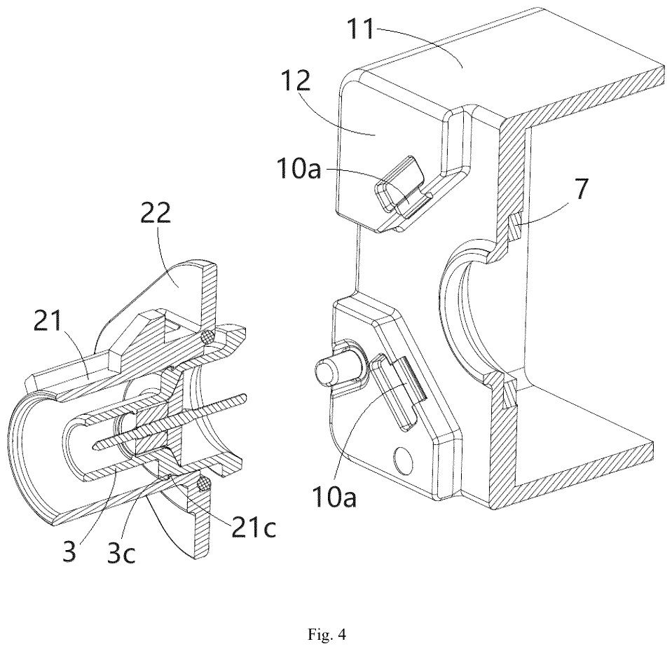

The rear cover 1 includes an outer peripheral wall 11, as shown in FIGS. 2 and 4, and a rear end wall 12, as shown in FIGS. 2-6, that enclose an accommodating chamber. As shown in FIGS. 3-5, the housing 2 includes a cylindrical portion 21 and a flange portion 22 formed at an end of the cylindrical portion 21. A fixing portion 10, as shown in FIG. 1, for fixing the flange portion 22 is formed on an outer side of the rear end wall 12. The flange portion 22 is fixed to the outer side of the rear end wall 12 by the fixing portion 10. A mounting hole 101, as shown in FIG. 3, in communication with an inner cavity of the cylindrical portion 21 is formed in the rear end wall 12 to allow an outer terminal 3 of a connector to be inserted into the cylindrical portion 21 via the mounting hole 101.

As shown in FIG. 3, a recess 12a adapted to fit with the flange portion 22 of the housing 2 is formed on the outer side of the rear end wall 12 of the rear cover 1. The flange portion 22 of the housing 2 is embedded in the recess 12a of the rear end wall 12.

As shown in FIGS. 1 and 3-4, the fixing portion 10 includes a plurality of riveting tabs 10a formed on a periphery of the recess 12a. The plurality of riveting tabs 10a are spaced apart in a circumferential direction of the flange portion 22 and are curled and riveted onto a periphery of the flange portion 22 to fix the flange portion 22 to the outer side of the rear end wall 12.

As shown in FIG. 3, a snap 21a is formed on an outer side of the cylindrical portion 21 of the housing 2. The snap 21a is adapted to be snap-fitted into a snap groove in a mating housing of a first mating connector to lock the housing 2 and the mating housing together.

As shown in FIG. 3, the cylindrical portion 21 of the housing 2 has a guide rib 21b extending in an axial direction thereof formed on an outer side thereof. The guide rib 21b is configured to fit with a guide groove in a mating housing of a first mating connector to guide the insertion of the housing 2 into the mating housing.

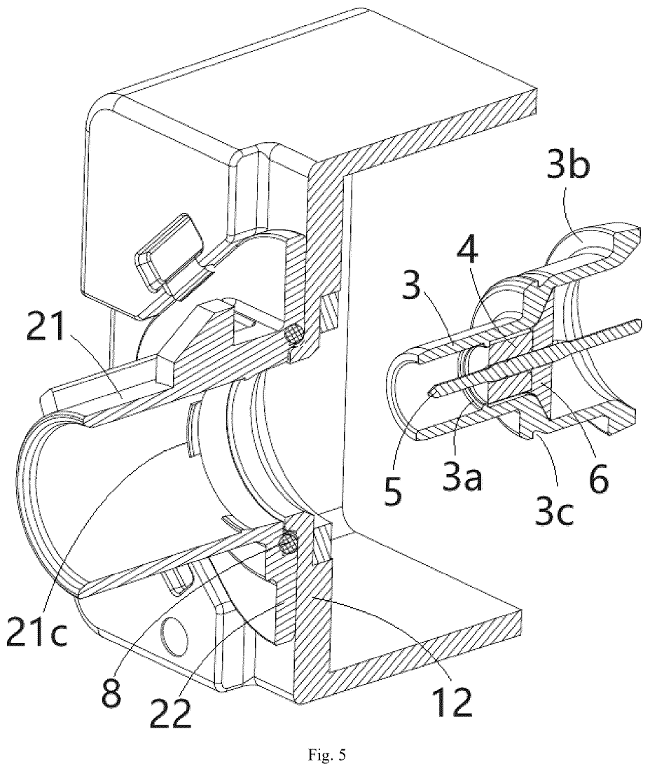

As shown in FIGS. 4-5, the cylindrical portion 21 of the housing 2 has a protruding rib 21c extending in a circumferential direction thereof formed on an inner side thereof. As shown in FIG. 4, the protruding rib 21c is adapted to engage with a groove 3c in the outer terminal 3 inserted into the cylindrical portion 21 to lock the outer terminal 3 in the cylindrical portion 21.

As shown in FIG. 5, the connector housing assembly further includes a sealing ring 8 compressed between the rear end wall 12 of the rear cover 1 and the flange portion 22 of the housing 2 to achieve sealing therebetween; thus, the sealing ring 8 is compressed between the rear end wall 12 of the rear cover 1 and the flange portion 22 of the housing 2 to form a seal therebetween. In the illustrated embodiment, a sealing ring mounting groove may be formed in the flange portion 22 of the housing 2, and the sealing ring 8 is mounted and positioned in the sealing ring mounting groove of the flange portion 22.

An exemplary embodiment of a coaxial connector will now be described with reference to FIGS. 1-6. The coaxial connector includes the connector housing assembly according to FIGS. 1-6 and an electrical connection module. As shown in FIGS. 2 and 5-6, the electrical connection module includes an outer terminal 3, an insulator 4, and an inner terminal 5. The outer terminal 3 is inserted into the cylindrical portion 21 of the housing 2 via the mounting hole 101 in the rear cover 1. The insulator 4 is inserted into the outer terminal 3 and formed with a central insertion hole. The inner terminal 5 is inserted into the central insertion hole of the insulator 4.

As shown in FIGS. 2 and 5, the electrical connection module further includes a first seal 6 formed by a sealant poured into the outer terminal 3. The first seal 6 is bonded to the outer terminal 3, the insulator 4, and the inner terminal 5 to achieve sealing between the outer terminal 3 and the insulator 4 and between the insulator 4 and the inner terminal 5.

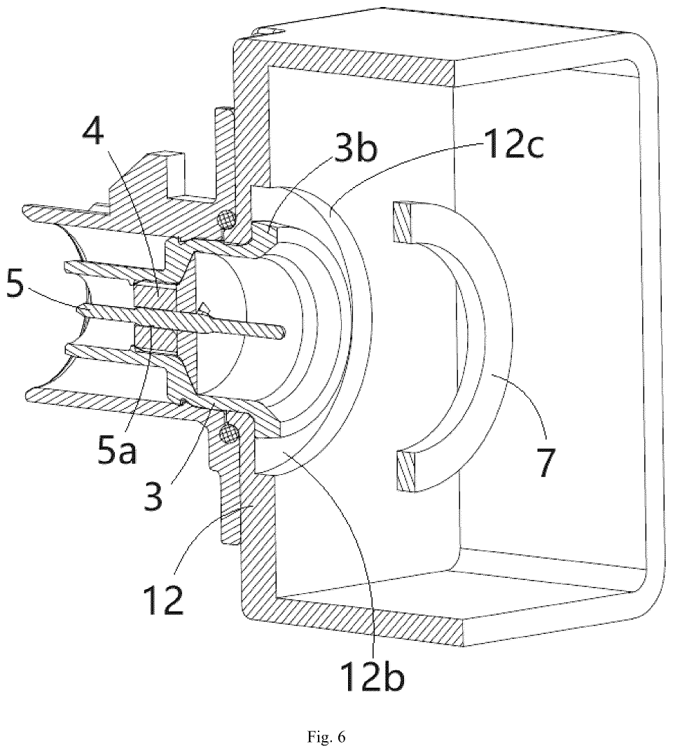

As shown in FIG. 5, a positioning flange 3a is formed around an inner side of the outer terminal 3. The positioning flange 3a axially abuts against a front end of the insulator 4. The first seal 6 is located at a rear end of the insulator 4 and is bonded to the rear end of the insulator 4. As shown in FIG. 6, a protrusion 5a is formed on the inner terminal 5. The protrusion 5a is in interference fit with the insulator 4 to fix the inner terminal 5 in the insulator 4.

The outer terminal 3 has a front end portion for mating with a first mating outer terminal of a first mating connector inserted into the cylindrical portion 21, and the inner terminal 5 has a front end portion for mating with a first mating inner terminal of the first mating connector inserted into the front end portion of the outer terminal 3. The outer terminal 3 has a rear end portion for mating with a second mating outer terminal of a second mating connector inserted therein, and the inner terminal 5 has a rear end portion for mating with a second mating inner terminal of the second mating connector inserted into the rear end portion of the outer terminal 3.

The rear cover 1 is a conductive metal part. The outer terminal 3 is in interference fit with the mounting hole 101 of the rear cover 1 to fix and electrically connect the outer terminal 3 to the rear cover 1.

As shown in FIGS. 2, 4, and 6, the coaxial connector further includes a second seal 7 formed by a sealant poured into an annular injection groove 12b on an inner side of the rear end wall 12. The second seal 7 is bonded between the rear end wall 12 of the rear cover 1 and a rear end of the outer terminal 3 to achieve sealing therebetween; thus, the second seal 7 is bonded between the rear end wall 12 of the rear cover 1 and a rear end of the outer terminal 3 to form a seal therebetween.

As shown in FIG. 6, an annular stepped portion 12c surrounding the mounting hole 101 is formed on the inner side of the rear end wall 12, and an annular flange portion 3b axially abutting against the inner side of the rear end wall 12 is formed on the rear end of the outer terminal 3. The annular injection groove 12b, as shown in FIG. 6, is defined between the annular stepped portion 12c and the annular flange portion 3b, and the second seal 7 is bonded between the annular stepped portion 12c of the rear end wall 12 and the annular flange portion 3b of the rear end of the outer terminal 3 to achieve sealing therebetween; thus, the second seal 7 is bonded between the annular stepped portion 12c of the rear end wall 12 and the annular flange portion 3b of the rear end of the outer terminal 3 to form a seal therebetween.

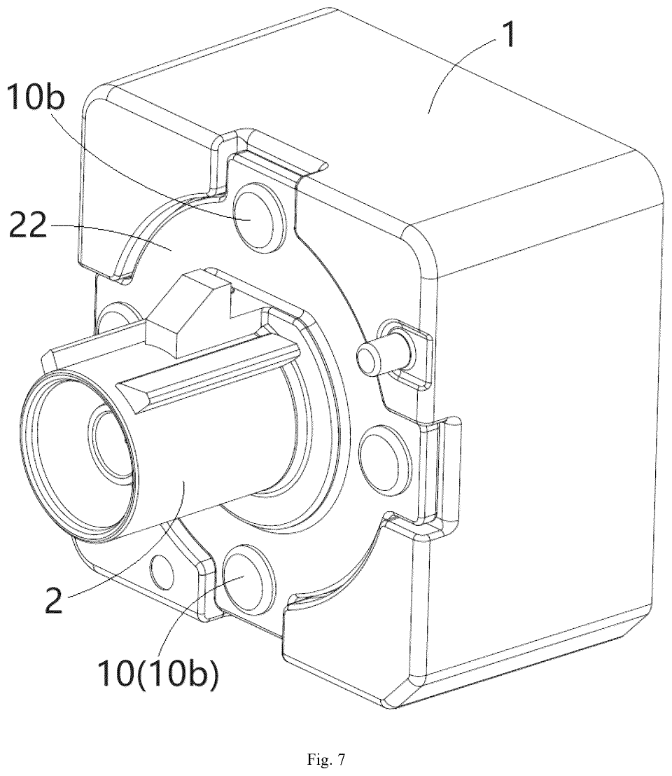

Another exemplary embodiment of a connector housing assembly will now be described with reference to FIGS. 7-12. As shown in FIG. 7, the connector housing assembly includes a rear cover 1 and a housing 2. The rear cover 1 may be a one-piece stamped metal part or a one-piece die-cast metal part, and the housing 2 may be a one-piece injection-molded plastic part.

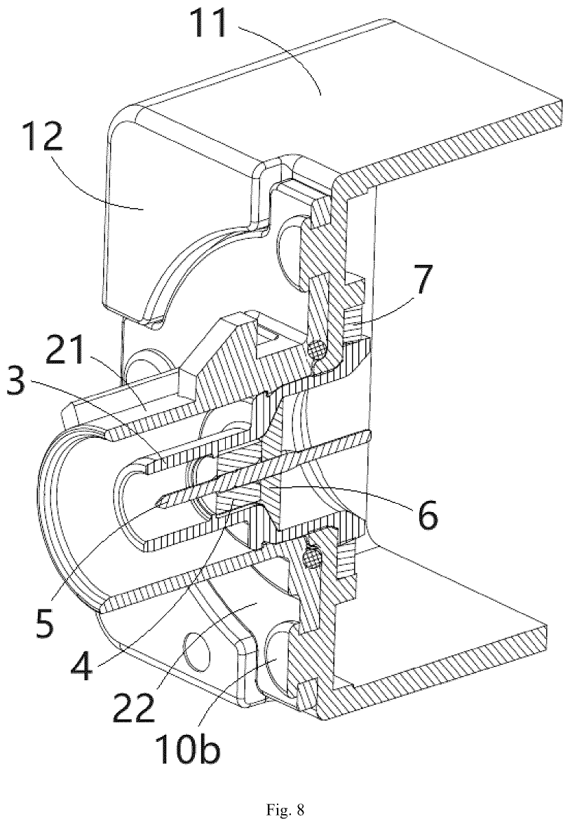

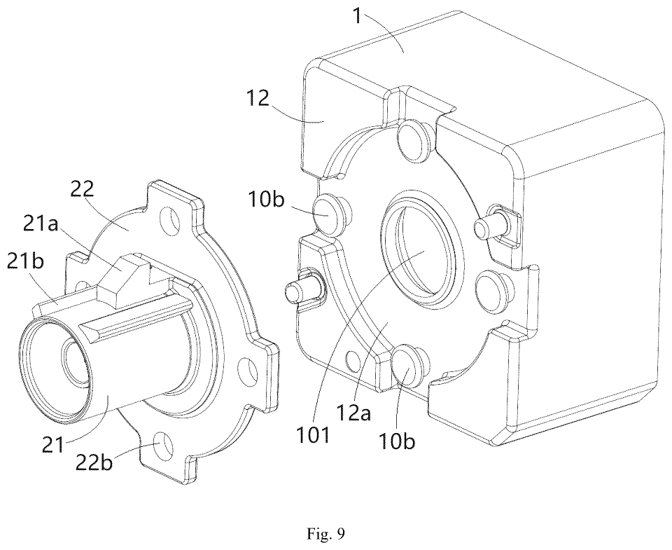

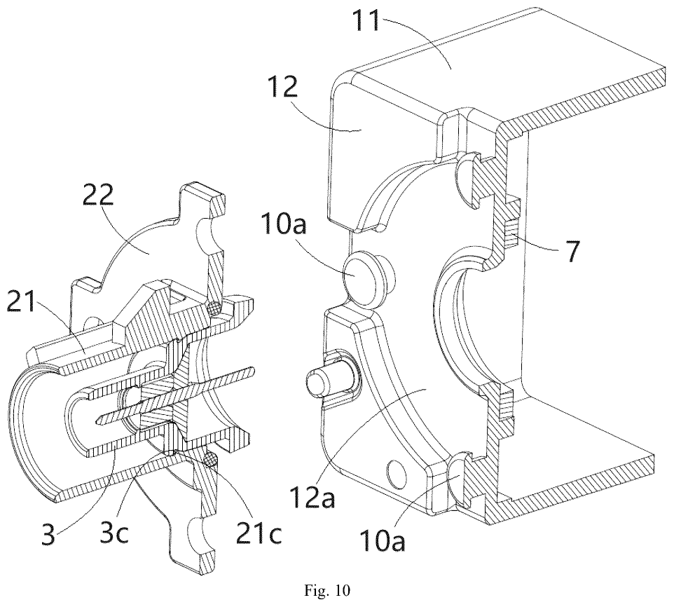

The rear cover 1 includes an outer peripheral wall 11, as shown in FIGS. 8 and 10, and a rear end wall 12, as shown in FIGS. 8-11, that enclose an accommodating chamber. As shown in FIGS. 8-11, the housing 2 includes a cylindrical portion 21 and a flange portion 22 formed at an end of the cylindrical portion 21. A fixing portion 10, as shown in FIG. 7, for fixing the flange portion 22 is formed on an outer side of the rear end wall 12. The flange portion 22 is fixed to the outer side of the rear end wall 12 by the fixing portion 10. A mounting hole 101, as shown in FIG. 9, in communication with an inner cavity of the cylindrical portion 21 is formed in the rear end wall 12 to allow an outer terminal 3 of a connector to be inserted into the cylindrical portion 21 via the mounting hole 101.

As shown in FIGS. 9-10, a recess 12a adapted to fit with the flange portion 22 of the housing 2 is formed on the outer side of the rear end wall 12 of the rear cover 1. The flange portion 22 of the housing 2 is embedded in the recess 12a of the rear end wall 12.

As shown in FIGS. 7-9, the fixing portion 10 includes a plurality of riveting posts 10b formed in the recess 12a. The plurality of riveting posts 10b being spaced apart in a circumferential direction of the flange portion 22. As shown in FIG. 9, a plurality of through holes 22b are formed in the flange portion 22. The plurality of riveting posts 10b respectively pass through the plurality of through holes 22b, and ends of the riveting posts 10b are curled and riveted onto peripheries of the through holes 22b to fix the flange portion 22 to the outer side of the rear end wall 12.

As shown in FIG. 9, a snap 21a is formed on an outer side of the cylindrical portion 21 of the housing 2. The snap 21a is adapted to be snap-fitted into a snap groove in a mating housing of a first mating connector to lock the housing 2 and the mating housing together.

As shown in FIG. 9, the cylindrical portion 21 of the housing 2 has a guide rib 21b extending in an axial direction thereof formed on an outer side thereof. The guide rib 21b is configured to fit with a guide groove in a mating housing of a first mating connector to guide the insertion of the housing 2 into the mating housing.

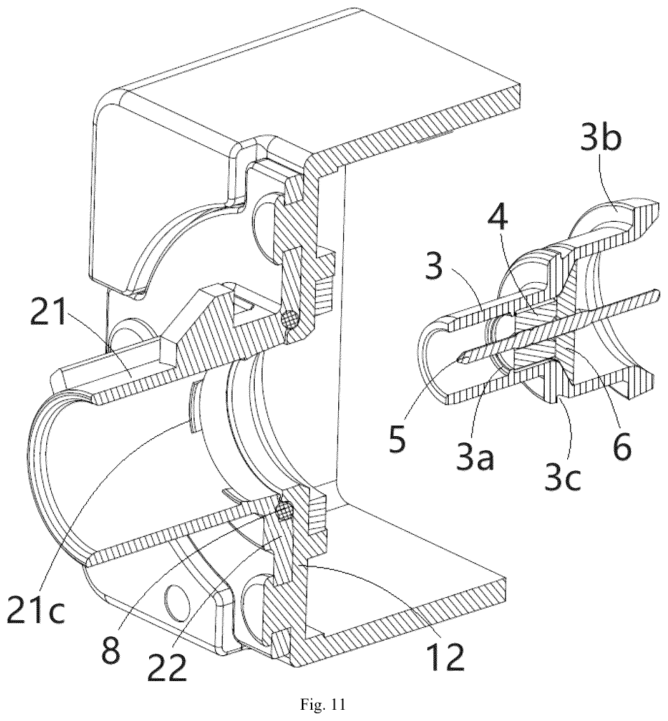

As shown in FIGS. 10-11, the cylindrical portion 21 of the housing 2 has a protruding rib 21c extending in a circumferential direction thereof formed on an inner side thereof. The protruding rib 21c being adapted to engage with a groove 3c in the outer terminal 3 inserted into the cylindrical portion 21 to lock the outer terminal 3 in the cylindrical portion 21.

As shown in FIG. 8, the connector housing assembly further includes a sealing ring 8 compressed between the rear end wall 12 of the rear cover 1 and the flange portion 22 of the housing 2 to achieve sealing therebetween; thus, the sealing ring 8 is compressed between the rear end wall 12 of the rear cover 1 and the flange portion 22 of the housing 2 to form a seal therebetween. In the illustrated embodiment, a sealing ring mounting groove may be formed in the flange portion 22 of the housing 2, and the sealing ring 8 is mounted and positioned in the sealing ring mounting groove of the flange portion 22.

An exemplary embodiment of a coaxial connector will now be described with reference to FIGS. 7-12. The coaxial connector includes the connector housing assembly according to FIGS. 7-12 and an electrical connection module. As shown in FIGS. 8 and 11-12, the electrical connection module includes an outer terminal 3, an insulator 4, and an inner terminal 5. The outer terminal 3 is inserted into the cylindrical portion 21 of the housing 2 via the mounting hole 101 in the rear cover 1. The insulator 4 is inserted into the outer terminal 3 and formed with a central insertion hole. The inner terminal 5 is inserted into the central insertion hole of the insulator 4.

As shown in FIGS. 8 and 11, the electrical connection module further includes a first seal 6 formed by a sealant poured into the outer terminal 3. The first seal 6 is bonded to the outer terminal 3, the insulator 4, and the inner terminal 5 to achieve sealing between the outer terminal 3 and the insulator 4 and between the insulator 4 and the inner terminal 5.

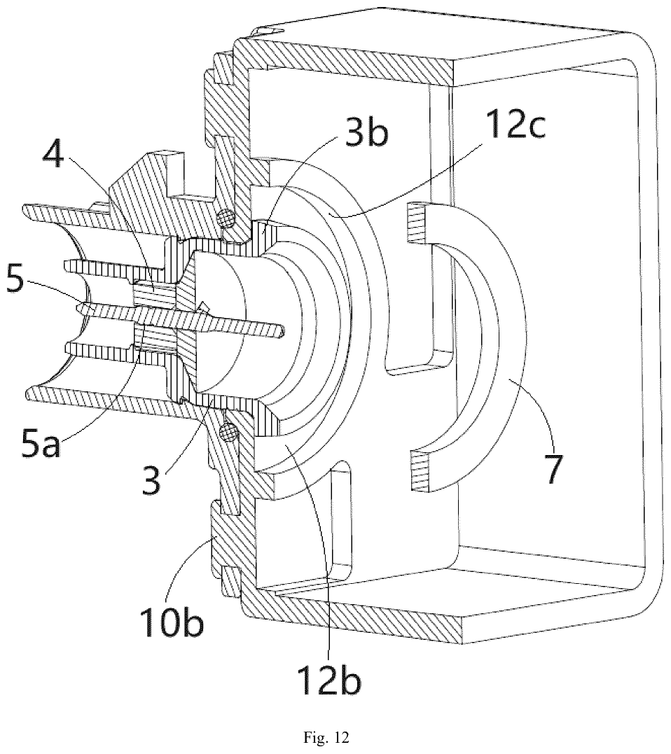

As shown in FIG. 11, a positioning flange 3a is formed around an inner side of the outer terminal 3. The positioning flange 3a axially abuts against a front end of the insulator 4, and the first seal 6 is located at a rear end of the insulator 4 and is bonded to the rear end of the insulator 4. As shown in FIG. 12, a protrusion 5a is formed on the inner terminal 5. The protrusion 5a is in interference fit with the insulator 4 to fix the inner terminal 5 in the insulator 4.

The outer terminal 3 has a front end portion for mating with a first mating outer terminal of a first mating connector inserted into the cylindrical portion 21, and the inner terminal 5 has a front end portion for mating with a first mating inner terminal of the first mating connector inserted into the front end portion of the outer terminal 3. The outer terminal 3 has a rear end portion for mating with a second mating outer terminal of a second mating connector inserted therein, and the inner terminal 5 has a rear end portion for mating with a second mating inner terminal of the second mating connector inserted into the rear end portion of the outer terminal 3.

The rear cover 1 is a conductive metal part. The outer terminal 3 is in interference fit with the mounting hole 101 of the rear cover 1 to fix and electrically connect the outer terminal 3 to the rear cover 1.

As shown in FIGS. 8, 10, and 12, the coaxial connector further includes a second seal 7 formed by a sealant poured into an annular injection groove 12b on an inner side of the rear end wall 12. The second seal 7 is bonded between the rear end wall 12 of the rear cover 1 and a rear end of the outer terminal 3 to achieve sealing therebetween; thus, the second seal 7 is bonded between the rear end wall 12 of the rear cover 1 and a rear end of the outer terminal 3 to form a seal therebetween.

As shown in FIG. 12, an annular stepped portion 12c surrounding the mounting hole 101 is formed on the inner side of the rear end wall 12, and an annular flange portion 3b axially abutting against the inner side of the rear end wall 12 is formed on the rear end of the outer terminal 3. The annular injection groove 12b is defined between the annular stepped portion 12c and the annular flange portion 3b, and the second seal 7 is bonded between the annular stepped portion 12c of the rear end wall 12 and the annular flange portion 3b of the rear end of the outer terminal 3 to achieve sealing therebetween; thus, the second seal 7 is bonded between the annular stepped portion 12c of the rear end wall 12 and the annular flange portion 3b of the rear end of the outer terminal 3 to form a seal therebetween.

In the foregoing various exemplary embodiments according to FIGS. 1-6 and 7-12, each housing 2 of each connector and each rear cover 1 are separately formed, thereby reducing the molding difficulty of each housing 2 according to FIGS. 1-6 and 7-12. For example, each housing 2 can be injection molded, thereby reducing the manufacturing costs. Moreover, in the foregoing various exemplary embodiments according to FIGS. 1-6 and 7-12, sealing between each outer terminal 3 of each connector and each rear cover 1 is achieved by sealant pouring, thereby reducing the size of each connector according to FIGS. 1-6 and 7-12.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “including” or “having” an element or a plurality of elements having a particular property may include additional such elements not having that property.

1. A connector housing assembly, comprising:
a rear cover having an outer peripheral wall and a rear end wall that enclose an accommodating chamber; and
a housing having a cylindrical portion and a flange portion formed at an end of the cylindrical portion, the flange portion is fixed to an outer side of the rear end wall by a fixing portion formed on the outer side of the rear end wall, an outer terminal of a connector is inserted into the cylindrical portion via a mounting hole formed in the rear end wall, the mounting hole is in communication with an inner cavity of the cylindrical portion.

2. The connector housing assembly of claim 1, wherein a recess fitting with the flange portion is formed on the outer side of the rear end wall, the flange portion of the housing is embedded in the recess of the rear end wall.

3. The connector housing assembly of claim 2, wherein the fixing portion has a plurality of riveting tabs formed on a periphery of the recess, the plurality of riveting tabs are spaced apart in a circumferential direction of the flange portion and are curled and riveted onto a periphery of the flange portion to fix the flange portion to the outer side of the rear end wall.

4. The connector housing assembly of claim 2, wherein the fixing portion has a plurality of riveting posts formed in the recess, the plurality of riveting posts are spaced apart in a circumferential direction of the flange portion, and a plurality of through holes are formed in the flange portion, each riveting post passes through one through hole, and ends of each riveting post is curled and riveted onto peripheries of one through hole to fix the flange portion to the outer side of the rear end wall.

5. The connector housing assembly of claim 1, wherein a snap is formed on an outer side of the cylindrical portion, the snap is snap-fitted into a snap groove in a mating housing of a first mating connector to lock the housing and the mating housing together.

6. The connector housing assembly of claim 1, wherein the cylindrical portion has a guide rib extending in an axial direction and formed on an outer side of the cylindrical portion, the guide rib is fit with a guide groove in a mating housing of a first mating connector to guide an insertion of the housing into the mating housing.

7. The connector housing assembly of claim 1, wherein the cylindrical portion has a protruding rib extending in a circumferential direction and formed on an inner side of the cylindrical portion, the protruding rib engages with a groove in the outer terminal inserted into the cylindrical portion to lock the outer terminal in the cylindrical portion.

8. The connector housing assembly of claim 1, wherein the rear cover is a one-piece stamped metal part or a one-piece die-cast metal part.

9. The connector housing assembly of claim 1, further comprising a sealing ring compressed between the rear end wall of the rear cover and the flange portion to form a seal therebetween.

10. The connector housing assembly of claim 1, wherein the housing is a one-piece injection-molded plastic part.

11. A coaxial connector, comprising:
a connector housing assembly including a rear cover and a housing, the rear cover has an outer peripheral wall and a rear end wall that enclose an accommodating chamber, the housing has a cylindrical portion and a flange portion formed at an end of the cylindrical portion, the flange portion is fixed to an outer side of the rear end wall by a fixing portion formed on the outer side of the rear end wall, a mounting hole formed in the rear end wall is in communication with an inner cavity of the cylindrical portion;
an electrical connection module having an outer terminal inserted into the cylindrical portion via the mounting hole;
an insulator inserted into the outer terminal and formed with a central insertion hole; and
an inner terminal inserted into the central insertion hole.

12. The coaxial connector of claim 11, wherein the electrical connection module has a first seal formed by a sealant poured into the outer terminal, the first seal is bonded to the outer terminal, the insulator, and the inner terminal to form a seal between the outer terminal and the insulator and between the insulator and the inner terminal.

13. The coaxial connector of claim 12, wherein a positioning flange is formed around an inner side of the outer terminal, the positioning flange axially abuts against a front end of the insulator, the first seal is at a rear end of the insulator and is bonded to the rear end of the insulator.

14. The coaxial connector of claim 11, wherein a protrusion is formed on the inner terminal, the protrusion is interference fit with the insulator to fix the inner terminal in the insulator.

15. The coaxial connector of claim 11, wherein the outer terminal has a front end portion for mating with a first mating outer terminal of a first mating connector inserted into the cylindrical portion, and the inner terminal has a front end portion for mating with a first mating inner terminal of the first mating connector inserted into the front end portion of the outer terminal.

16. The coaxial connector of claim 11, wherein the outer terminal has a rear end portion for mating with a second mating outer terminal of a second mating connector inserted therein, and the inner terminal has a rear end portion for mating with a second mating inner terminal of the second mating connector inserted into the rear end portion of the outer terminal.

17. The coaxial connector of claim 11, wherein the rear cover is a conductive metal part, the outer terminal is interference fit with the mounting hole to fix and electrically connect the outer terminal to the rear cover.

18. The coaxial connector of claim 11, further comprising a second seal formed by a sealant poured into an annular injection groove on an inner side of the rear end wall, the second seal is bonded between the rear end wall of the rear cover and a rear end of the outer terminal to form a seal therebetween.

19. The coaxial connector of claim 18, wherein an annular stepped portion surrounding the mounting hole is formed on the inner side of the rear end wall, and an annular flange portion axially abutting against the inner side of the rear end wall is formed on the rear end of the outer terminal, the annular injection groove is defined between the annular stepped portion and the annular flange portion, the second seal is bonded between the annular stepped portion of the rear end wall and the annular flange portion of the rear end of the outer terminal to form a seal therebetween.
